(19) United States
(12) Patent Application Publication
(10) Pub. No.: US 2005/0108690 A1
(43) Pub. Date: May 19, 2005

(54) System and method of generating applications for mobile devices

(75) Inventors: Allen N. L. Lau, Markham (CA); Oliver Attila Tabay, Toronto (CA)

Correspondence Address: BERESKIN AND PARR, 40 KING STREET WEST, BOX 401, TORONTO, ON, M5H 3Y2, CA

(73) Assignee: Tira Wireless Inc., Toronto (CA)

(21) Appl. No.: 10/713,024

(22) Filed: Nov. 17, 2003

(51) Int. Cl. G06F 9/45

(52) U.S. Cl. 717/136

(57) ABSTRACT

A method and system of generating target applications from Java reference applications for a particular combination of mobile devices is provided. The method includes the steps of: a) unpacking the reference application into a number of class files; and b) transforming the reference application into the target application by a plug-in. The plug-in is capable of transforming different reference applications into corresponding target applications for a particular combination of the reference mobile device and the target mobile device. The system includes a transformation engine and a plug-in corresponding to the reference/target mobile device combination. The plug-in includes an XML file and pieces of software code to modify corresponding portions of the reference application not supported by the target mobile device. The XML file directs the transformation engine to identify the unsupported portion of the reference application and to modify the portion with the selected software code.

### FIELD OF THE INVENTION

The invention relates to automated application development. In particular, the invention relates to systems and methods for generating applications for mobile devices from a reference Java application.

### BACKGROUND OF THE INVENTION

The popularity of mobile devices, such as wireless phones, pagers, and personal digital assistants (PDAs) continues to increase. As more and more people acquire mobile devices, the number of different types of devices available have also increased, as well as the capabilities of such devices. Many of these mobile devices are customized using software applications which run on these devices. Examples of application programs available on mobile devices include games, mail programs, and contact management applications.

Application programs are written for a particular computer architecture (also referred to as an instruction set), as well as a particular operating system, which is supported by the architecture. Application programs written for a combination of one particular architecture and operating system cannot execute on a different architecture and/or different operating system. This is due to the fact that the instruction sets and/or the interface to the libraries of the different architectures and operating systems are different. For this reason, applications that are designed to run on one type of mobile device with a particular architecture operating system combination may not run on another type of mobile device with a different operating system architecture combination. For example, applications which run on Nokia™ devices typically do not run on Motorola™ devices, even when both of these devices support Java.

Several methods to migrate an application from an architecture operating system combination for one mobile device to a different architecture operating system combination for a target mobile device are known.

One such method is the so-called “porting approach”. With the porting approach the software developer takes the source code for the application program to be converted and runs the source code through a compiler developed for the target mobile device.

One disadvantage of porting is that a relatively large amount of time is required to port an application program to the target mobile device. In addition, porting requires significant human intervention, as it is almost certain that the source code has to be modified before it can be compiled and executed properly on the target mobile device. This in turn requires the developer to maintain and manage a different version of the source code for each target mobile device.

Another known method is referred to as the “on-line interpretation” approach. In this method, a software module called an “interpreter” interprets instructions from an executable version of the application program written to run on the first mobile device. The interpreter chooses the required instructions or routines required for the application to execute the same functions in the target mobile device. The interpreter essentially runs as an emulator, which responds to an executable file of the application which runs on the first mobile device, and in turn, creates a converted executable file which runs on the target mobile device.

A disadvantage of the on-line interpretation method is that the interpreter must be able to be loaded and executed on the target mobile device. While this is possible on some systems like desktop personal computer systems, it is not feasible for mobile devices due to size and performance limitations.

Accordingly, there is a need for systems and methods for more quickly and efficiently generating applications for different types of mobile devices from a reference application which runs on one type of mobile device.

### SUMMARY OF THE INVENTION

According to a first aspect of the invention, a method of generating a target application from a reference application is provided. The reference application is a Java application adapted to execute on a reference mobile device and the target application is configured for a target mobile device. The method comprises: a) unpacking the reference application into a plurality of class files; and b) transforming the reference application into the target application by a plug-in. The plug-in is configured to transform different reference applications into corresponding target applications for a particular combination of the reference mobile device and the target mobile device.

Preferably, the plug-in comprises an instruction file and at least one library, and the transformation step comprises the instruction file instructing a transformation engine to modify a portion of the reference application not supported by the target mobile device with a selected software code stored in the library.

According to a second aspect of the invention, a system for transforming Java reference applications for a reference mobile device into corresponding target applications for a target mobile device is provided. The system comprises a transformation engine and a plug-in. The plug-in comprises: i) an instruction file; and ii) a selected software code adapted to modify a portion of the reference application not supported by the target mobile device. The transformation engine is adapted to access the instruction file, which directs the transformation engine to identify the portion of the reference application and to modify the portion with the selected software code.

Preferably, the instruction file is a XML file and the plug-in comprises a plurality of software codes stored in a library.

The present invention automates the process of migrating applications to target devices which may not otherwise support the reference application, thereby greatly reducing the development time required to migrate the applications, as well as reducing the time and expense required to manage and maintain multiple versions of source code.

### BRIEF DESCRIPTION OF THE DRAWINGS

In the accompanying drawings:

FIG. 1 is a block diagram of a preferred embodiment of a system of generating applications for mobile devices according to the present invention; and

FIG. 2 is a flow diagram showing the operation of the system of FIG. 1.

### DETAILED DESCRIPTION OF THE PREFERRED EMBODIMENT

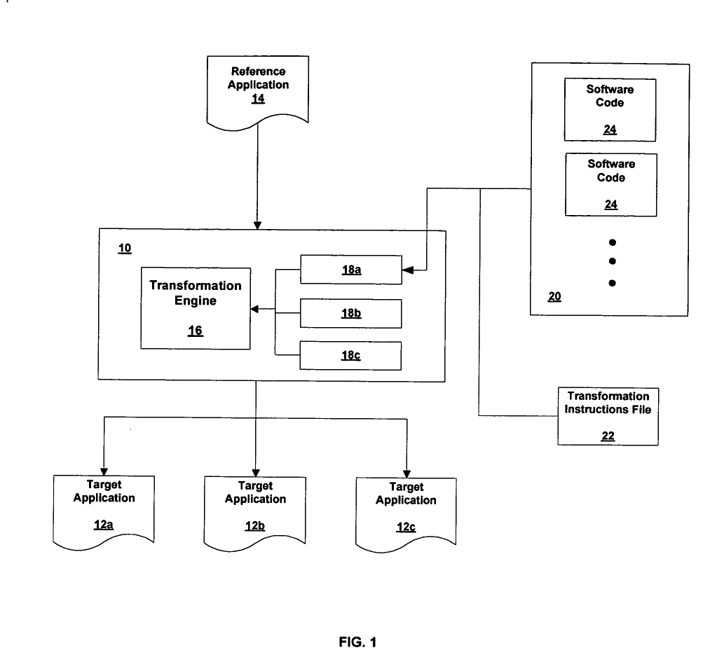

FIG. 1 shows a system 10 for automatically generating any suitable number of target applications from a reference application 14, according to a preferred embodiment of the present invention. For clarity, three target applications 12a, 12b, and 12c are shown.

The reference application 14 is written to execute on one type of mobile device which supports Java. The mobile device on which the reference application runs will be referred to herein as a reference mobile device (not shown).

The reference application 14 is a Java application which includes any suitable number of class files (not shown). Preferably, the reference application is written for the Java 2 Platform, Micro Edition (J2ME), but could be written on any other Java platform for mobile devices. The reference application 14 is composed of a JAD/JAR (Java Application Descriptor/Java Archive) pair. The mobile device may be any portable computing device, such as a wireless phone, pager, Personal Digital Assistant (PDA), set-top box, or an in-vehicle telematic system.

The J2ME platform is a set of open standard Java Application Program Interfaces (APIs) defined through the Java Community Process program by expert groups that include leading device manufacturers, software vendors and service providers. The J2ME architecture defines configurations, profiles and optional packages as elements for building complete Java runtime environments that meet the requirements for a broad range of devices. Each combination is optimized for the memory, processing power, and input/output capabilities of a related category of devices.

J2ME configurations are composed of a Java Virtual Machine (JVM) and a set of class libraries. They provide the base functionality for a particular range of devices that share similar characteristics, such as network connectivity

Continuing to refer to FIG. 1, the system 10 includes a transformation engine 16. The transformation engine 16 is a software module which runs on a computer, such as, for example, a personal computer having a central processing unit (CPU) and a memory. The transformation engine 16 is preferably a Java application that may be configured to run on a desktop personal computer or a server, although it will be understood that the transformation engine may be written in any suitable language.

The system 10 also includes any suitable numbers of plug-ins 18 which are preferably stored in the computer memory and which may be accessed by the transformation engine 16. For clarity, three plug-ins 18a, 18b, 18c are shown in FIG. 1. Each plug-in 18a, 18b, 18c is capable of transforming applications for a specific combination of a reference mobile device and a target mobile device. As used herein, a “target mobile device” is any mobile device which does not support the reference application 14. Preferably, the target mobile device has a different architecture and/or a different operating system from the reference mobile device. The target mobile device does not “support” the reference application 14 when the reference application 14 does not execute on the target device, or when the reference application is not optimized for execution on the target mobile device. Examples of a lack of optimization may include executing slowly or not rendering graphics correctly on the target mobile device.

For example, the reference device may be a Nokia™ Series 40 wireless telephone, and the target devices may be a Samsung™ S300, a Motorola™ T720, and a Sharp™ GX10 wireless telephone. In this example, plug-in 18a corresponds to the combination of Nokia™ Series 40 and Samsung™ S300 phones. Plug-in 18b corresponds to the combination of Nokia™ Series 40 and Motorola™ T720 phones. Plug-in 18c corresponds to the combination of Nokia™ Series 40 and Sharp™ GX10 phones.

It will be understood by those skilled in the art is that the term “plug-in” used in this application includes any file or set of instructions which are capable of instructing a computer to transform applications for a specific combination of a reference and target mobile device.

The target applications 12a, 12b, 12c may be Java applications if the target mobile device supports Java. Alternatively, the target applications may be any other type of application supported by a particular target mobile device, such as BREW™ or Symbian™.

Continuing to refer to FIG. 1, each plug-in 18a, 18b, 18c includes a library 20 and an instruction file 22. For clarity, only the library and instruction file for plug-in 18a have been shown. However, it will be understood by those skilled in the art that the remaining plug-ins 18b and 18c also have corresponding libraries and instruction files. The library 20 includes a collection of pieces of software code 24 required to transform the reference application 14 into the target application 12a.

The instruction file 22 is preferably an Extensible Markup Language (XML) file which contains a list of instructions to the transformation engine 16 to generate the target application 12a from the reference application 16.

The library 20 and the instruction file 22 for inserting the software code 24 into the reference application 14 are created in a manner well known in the art, based on a list of known differences in the characteristics between the reference mobile device and the target mobile device. Typical device characteristics where such differences may be present include without limitation: memory, processing speed, key mapping, screen size, font size, image/sound file format differences, device-specific Java API calls, and non-standard behavior of standard Java API calls.

Some examples of the differences and how they are addressed in the plug-ins 18a, 18b, 18c are provided below.

### EXAMPLE 1

The list of target mobile device APIs are compared with the list of APIs for the reference mobile device. Each API call on the reference mobile device is mapped to the corresponding API call on the target mobile device. If any API call is not present on the target a mobile device, a new method is created to add to the target device class files to provide this functionality. The new method is one example of the software code 24 stored in the library 20.

### EXAMPLE 2

The keypad functionality of the reference mobile device is compared with that of the target mobile device. Any key mapping behavioral differences are then captured and appropriate mappings are then developed. For example, The left and right softkeys on the mobile device are not defined in the J2ME specification and therefore, the “key value” associated with each of the softkeys may be different for each device implementation.

### EXAMPLE 3

The display size of the reference mobile device is compared with that of the target mobile device. Differences are captured and appropriate scaling algorithms are developed.

After each software code 24 in the library 20 is written to address a particular difference in a device characteristic (such as those shown in the above examples), the instruction file 22 is created to provide step-by-step instructions to the transformation engine 16 on how to use each software code in the library 20 to modify the reference application 14, and the order for making the changes. For example, the instruction file 22 may include instructions, such as whether the software code should replace certain code in the reference application 14, or should merely be added to the existing code.

One embodiment of a XML instruction file 22 for the plug-in 18a is provided below.

<class-actions>

<class-action orderId=“10” description=“replace the Canvas

repaint with tiraPaint implementation” dolt=“true”>

<action-

class>com.tira.coreserv.transformation.classactions.ReplaceMethodCallAction</action-class>

<arg

name=“oldClassName”>javax/microedition/lcdui/Canvas</arg>

<arg name=“oldMethodName”>repaint</arg>
<arg

name=“newClassName”>com/nokia/mid/ui/FullCanvas</arg>

<arg name=“newMethodName”>tiraRepaint</arg>

</class-action>
<class-action orderId=“20” description=“replace Canvas's

drawString method call with Tira's drawString” dolt=“true”>

<action-

class>com.tira.coreserv.transformation.classactions.ReplaceStaticAction</action-class>

<arg name= “oldClassName”>

javax/microedition/lcdui/Graphics</arg>

<arg name=“oldMethodName”>drawString</arg>
<arg

name=“newClassName”>com/tira/packaging/platform/TiraStaticMethods</arg>

<arg name=“newMethodName”>drawString</arg>

</class-action>
<!-- replaces a the paint method for double buffering-->
<class-action orderId=“90” description=“double buffer”

dolt=“true”>

<action-

class>com.tira.coreserv.transformation.classactions.ReplacePaintCallAction</action-class>

</class-action>
<!-- absorb paints
optional arguments:

interval - repaint interval

-->
<class-action orderId=“100” description=“paint absorbtion”

dolt=“true”>

<action-

class>com.tira.coreserv.transformation.classactions.PaintAbsorbtionAction</action-class>

<arg name=“interval”>100</arg>

</class-action>
<!-- resolve the key mapping-->
<class-action orderId=“110” description=“key mapping”

dolt=“true”>

<action-

class>com.tira.coreserv.transformation.classactions.KeyMappingAction</action-class>

</class-action>
<!--
<class-action orderId=“60” description=“flipImage”

dolt=“true”>

<action-

class>com.tira.coreserv.transformation.classactions.FlipImageAction</action-class>

</class-action>

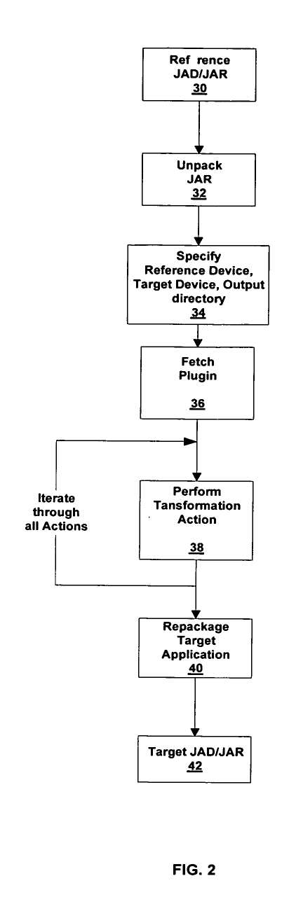

The operation of the preferred embodiment of the present invention will now be described with reference to FIGS. 1 and 2.

The operation begins at step 30, where the reference application 14 (written to execute on the reference device), preferably packaged in a JAD/JAR pair is loaded into the memory of the personal computer.

The process then moves to step 32, where the JAR file of the reference application 14 is unpacked by the transformation engine 16 into bytecode consisting of class files. The class file is a precisely defined file format to which Java programs are compiled. The class file may be loaded by any JVM implementation. The Java class file contains all components required by the JVM in order for the application to run. The class file contains the following major components: constant pool, access flags, super class, interfaces, fields, methods, and attributes. The order of class file components is strictly defined so that JVMs are able to correctly identify and execute the various components of the class file.

At step 34, the identities of reference mobile device and the chosen target mobile are input into the transformation engine 16. In addition, an output directory for the target application 12 is input into the system 10. If generation of multiple target applications 12a, 12b, 12c for different target mobile devices is desired, the list of target devices is also input into the system 10.

At step 36, the transformation engine 16 selects one of the device plug-ins 18a, 18b, 18c which corresponds to the inputted combination of reference and target mobile device. For example, if the selected reference mobile device is the Nokia™ Series 40 wireless phone and the target mobile device is the Samsung™ S300 wireless phone, plug-in 18a is selected.

The operation then moves to step 38, where the transformation engine instructs the computer to perform the transformation. The transformation step is performed differently depending on whether the target mobile device supports Java. In the present embodiment, the target mobile device is the Samsung™ S300 wireless phone, which does support Java.

Accordingly, the transformation engine 16 performs the transformation step by carrying out the first instruction in the instruction file 22 of the plug-in 18a. If such instruction requires modifying a particular element of a class file, the transformation engine 16 scans the class files of the reference application 14 and locates the relevant class file. The transformation engine 16 may then modify the relevant class file with a selected software code 24. Specifically, the instruction file 22 instructs the transformation engine 16 to copy the selected software code 24 from the library 20 of the plug-in 18a and to inject it into the appropriate place in the relevant class file.

Examples of different types of modifications which may be performed by the transformation engine 16 are set out below:
1. Add a new method to a class file, as follows:
   a. insert the new method info in the class file method list;
   b. insert the method name and the in the class file constant pool;
   c. insert the body of the source method in the class file;
   d. adjust the newly inserted method body with the class file context (validate branch instruction targets and instruction length).
2. Rename an existing method in a class file, as follows:
   a. find the method definition in the constant pool; and
   b. rename the method's name entry in the constant pool.
3. Replace the method call of a particular object [e.g. “o1.method1(arg1, arg2 . . . argn)”] with the method call of another object in a class file [e.g. “o2.method2(arg1, arg2 . . . argn)”], as follows:
   a. search all the references of the o1.method1 call in the class file; and
   b. —replace the references with o2.method2.
4. Replace an original method call [e.g. “o1.method1(arg1, arg2 . . . argn)”] with a static method call [e.g. “static o2.method2(o1, arg1, arg2 . . . argn)”] in a class file, as follows:
   a. search all the references of the o1.method1 call in the class file; and
   b. replace the references with o2.method2.
5. Rename constant pool entries in a class file, as follows:
   a. search for the constant pool entry; and
   b. rename it.
6. Insert a new class file, as follows:
   a. add the reference of the inner class to the target class file; and
   b. copy the compiled inner class to the target class file.

A specific example of a transformation carried out by plug-in 18a is provided below. The transformation relates to the implementation of the method drawRoundRect of the javax.microedition.lcdui.Graphics class on a Samsung™ S300 target mobile device. This implementation deviates from the reference mobile device (Nokia™ Series 40), which follows the MIDP (Mobile Information Device Profile) specification from the J2ME family.

The purpose of the above method is to draw the outline of a rounded corner rectangle at specified coordinates with the specified width, height, arc width and arc height. However, on the Samsung™ S300 device, the rounded corners are not rendered in the desired manner on the screen. As a result, the reference application 14, which runs on the reference mobile device (in this example, Nokia™ Series 40) and uses the drawRoundRect method, will not run in the desired manner on the Samsung™ S300 target mobile device.

To address this issue, the method call to the drawRoundRect method is replaced by modifying the class file(s) that originate the method call. A two-step process is used to replace the method call.

First, a new class file is added to the reference application 14. The new class file contains a static method, which has the same method signature as the method being replaced except that a parameter is added to the beginning of the list of parameters. The newly added parameter is of the same type as the “this” object of the method being replaced.

For greater clarity, an excerpt of the Graphics class that contains the drawRoundRect method is provided below.

package javax.microedition.lcdui;
package javax.microedition.lcdui;
public Class Graphics
{

.
.
.
public void drawRoundRect(int x,

int y,
int width,
int height,
int arcWidth,
int arcHeight)

.
.
.

}

As discussed above, a new class called Replacement is added. An excerpt of the Replacement class is provided below.

import javax.microedition.lcdui.Graphics;
public Class Replacement
{

.
.
.
static public void newDrawRoundRect(Graphics g,

int x,
int y,
int width,
int height,
int arcWidth,
int arcHeight)

.
.
.

}

Second, the method calls to the original method are replaced by calls to the static method. In the above example, the method calls to Graphics.drawRoundRect are replaced by calls to Replacement.newDrawRoundRect. In most object-oriented languages, such as Java, the “this” pointer is passed as an implicit argument to every member method. Typically, “this” is passed in as the first argument of any member method. Therefore, changing the method call merely requires renaming the class type and the method name. The parameter stack does not require alteration in this particular example.

Another example of a transformation action provided in plug-in 18b (i.e. where the reference mobile device is the same, and the target mobile device is a Motorola™ wireless phone) is provided below. In this example, the reference application 14 utilizes the Nokia™ Sound API (com.nokia.sound.Sound class) for playing sound files, while the target device is a Motorola™ device which has its own proprietary API (com.motorola.midi.MidiPlayer class) for playing sound files. To redirect the method call, a class with the same name as the Nokia™ Sound API (com.nokia.sound.Sound class) is added to the class files. The method calls are remapped to the appropriate method calls in the com.motorola.midi.MidiPlayer class.

Referring again to FIGS. 1 and 2, step 38 is then repeated until the transformation engine 16 completes all of the actions in the instruction file 22. After the completion of the steps in the instruction file 22, the transformation engine 16 has transformed the class files of the reference application 14 into the appropriate bytecode for the target application 12a.

The operation then moves to step 40, where the target application 12a is repackaged into executable code for the target application 12a, as described below.

In the present embodiment, where the target application 12a is a Java application, step 40 may include obfuscating the class files of the target application 12a. The obfuscation is performed in order to reduce the resulting target JAR and to remove any unused fields and methods.

Step 40 may also include pre-verification of the class files of the target application 12a. The pre-verification adds supplementary information to the bytecode (such as the stack map attributes), which is used by the JVM, and is also used to validate the bytecode prior to run-time. The bytecode for the target applications 12a is then packaged into a JAR file and the corresponding JAD file is modified in accordance with the changes.

The target application 12a generated by the system 10 may require some additional manual modification to optimize its performance on the target mobile device.

A different target application 12b or 12c may be created from the reference application 14, by returning to step 34 and selecting plug-in 18b or 18c respectively. The above process may then be repeated to generate the target applications 12b or 12c.

Alternatively, a different reference application may be selected for transformation for the same reference mobile device/target mobile device combination. In this case, the process must be repeated for the second reference application starting with step 30. In this manner many different reference applications may be transformed into corresponding target applications using a single plug-in (such as plug-in 18a for the Nokia™ Series 40/Samsung™ S300 wireless telephone combination).

In the above example, the plug-in 18a may be used to automatically transform a variety of different reference applications (such as different games) which run on the Nokia™ Series 40 phones into corresponding target applications for the Samsung™ S300 phones. This provides the advantage of allowing developers to reduce development time by only having to write an application for a single reference device. The present invention automates the process of migrating the application to target devices which may not otherwise support the reference application, thereby greatly reducing the development time required to migrate the applications, as well as reducing the time and expense required to manage and maintain multiple versions of source code.

In addition, the present invention provides an advantage over the prior art on-line interpretation method by elimination the need to run the transformation process on the target mobile device, which may not have the performance characteristics for such a task.

In an alternative embodiment, where the target mobile device does not support Java, the class files of the reference application 14 are translated into the source code of a language target mobile device. One example of such a language may be C++, which is supported by target mobile devices using the BREW™ or Symbian™ platforms. As the standard Java libraries, such as the MIDP classes, are utilized within the reference application 14, an empty implementation, usually called a “stub” implementation is also supplied to the code translator in order to generate the source code. Once the source code is generated, the code that corresponds to the stub implementation is then replaced with an implementation that maps to the method calls in the native libraries for the target device. The source code is then recompiled and packaged into an executable in the native format of the target device.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A method of generating a target application from a reference application, the reference application being a Java application adapted to execute on a reference mobile device, the target application being configured for a target mobile device, the method comprising:
a) unpacking the reference application into a plurality of class files;
b) transforming the reference application into the target application by a plug-in, wherein the plug-in is adapted to transform a plurality of different reference applications into a corresponding plurality of target applications for a predetermined combination of the reference mobile device and the target mobile device.

2. The method of claim 1, wherein the reference application is in bytecode during the transformation step.

3. The method of claim 2, wherein the plug-in comprises an instruction file and at least one library, wherein the transformation step comprises the instruction file instructing a transformation engine to modify a portion of the reference application with a selected software code stored in the library, wherein the portion of the reference application is not supported by the target mobile device.

4. The method of claim 3, wherein the transforming step comprises modifying at least one of a plurality of class files in the reference application.

5. The method of claim 4, wherein the transformation step comprises adding a new class file to the reference application.

6. The method of claim 4, wherein the modifying step comprises at least one action selected from the group of: adding a new method, renaming an existing method, replacing a first object method call with a second object method call, replacing the first object method call with a static method call, renaming a constant pool entry, and inserting a new inner class to an existing class.

7. The method of claim 6, further comprising saving the target application to a computer readable medium.

8. The method of claim 7, further comprising repeating step (a) and step (b) to transform the plurality of different reference applications into the plurality of corresponding target applications.

9. The method of claim 1, further comprising selecting a predetermined plug-in from a plurality of the plug-ins, the predetermined plug-in corresponding to the predetermined combination of the reference mobile device and the target mobile device, each of the plurality of the plug-ins corresponding to a different combination of the reference mobile device and the target mobile device.

10. The method of claim 3, further comprising repackaging the target application into executable code.

11. The method of claim 10, wherein the repackaging step further comprises obfuscating the target the class files of the target application.

12. The method of claim 10, wherein the repackaging step further comprises pre-verifying the class files of the target application.

13. The method of claim 3, wherein the target application is a non-Java application.

14. A system for transforming Java reference applications adapted to execute on a reference mobile device into corresponding target applications configured for a target mobile device, the system comprising:
a) a transformation engine; and
b) a plug-in comprising:
i) an instruction file; and
ii) a selected software code adapted to modify a portion of the reference application not supported by the target mobile device;
wherein the transformation engine is adapted to access the instruction file, the instruction file being adapted to direct the transformation engine to identify the portion of the reference application and to modify the portion with the selected software code.

15. The system of claim 14, wherein the instruction file comprises an XML file.

16. The system of claim 15, wherein the plug-in comprises a library, the library being adapted to store a plurality of the software codes adapted to modify a plurality of the portions.

17. The system of claim 16, wherein the transformation engine is a Java application.

18. The system of claim 15, further comprising a plurality of the plug-ins, each of the plurality of the plug-ins corresponding to a different combination of reference and target mobile device, wherein the transformation engine is adapted to choose a selected one of the plug-ins corresponding to the different combination.

19. The system of claim 16, wherein the target applications are Java applications.

20. The system of claim 16, wherein the target applications are non-Java applications.
